(19) United States
(12) Patent Application Publication
(10) Pub. No.: US 2009/0102449 A1
(43) Pub. Date: Apr. 23, 2009

(54) POWER SUPPLY DEVICE WITH VOLTAGE CONVERTER CIRCUIT

(75) Inventors: Wen-Hsing Chang, ChuPei City (TW); Ming-Yao Dong, ChuPei City (TW)

Correspondence Address: NIKOLAI & MERSEREAU, P.A., 900 SECOND AVENUE SOUTH, SUITE 820, MINNEAPOLIS, MN, 55402, US

(73) Assignee: SYSPOTEK CORPORATION, ChuPei City (TW)

(21) Appl. No.: 12/233,161

(22) Filed: Sep. 18, 2008

(30) Foreign Application Priority Data
Oct. 19, 2007 (TW) 96139215

(51) Int. Cl. G05F 3/08

(52) U.S. Cl. 323/311

(57) ABSTRACT

A power supply device with voltage converter circuit comprises a power supply device, a boost loop, a buck loop, and a control unit. The power supply device supplies power by any means. The boost loop is used to step up the voltage of power output by the power supply device. The buck loop is used to step down the voltage of power output by the power supply device. The boost loop and the buck loop are electrically connected in parallel. The control unit selects the use of boost loop or buck loop for the voltage conversion of the power supply device. The control unit monitors the power output of the power supply device and controls the action of the boost loop or the buck loop such that the power supply device would output voltage desired by the system via voltage conversion.

### FIELD OF THE INVENTION

The present invention relates to a power supply device with voltage converter circuit, more particularly a power supply device, even a fuel cell electrically connected to a parallel-connected boost loop and buck loop to regulate the voltage output by the power supply device.

### BACKGROUND OF THE INVENTION

Today's electronic circuit technology typically involves reciprocal support among varying systems and modules to achieve greater functional sophistication, work efficiency and functional versatility. But different systems and modules do not necessarily have the same operating voltage. Some special systems or modules must step up or step down the voltage to achieve specific purpose. The voltage modulation technology disclosed in this invention is able to easily modulate voltage for use in various systems and modules. This invention is also able to control the operation of the voltage converter more efficiently with the use of different control units so as to render voltage conversion more efficient.

To address the drawback of prior output voltage modulation methods, the invention aims to provide an efficient and convenient voltage modulation method.

### SUMMARY OF THE INVENTION

The present invention provides a power supply device with voltage converter circuit that comprises a boost loop and a buck loop, and through a control unit, controls the electronic switch of a voltage conversion unit to obtain a constant voltage/current at the output terminal.

To realize the aforesaid object, the present invention provides a power supply device, a boost loop, a buck loop and a control unit. The power supply device is a device that supplies power by any means; the boost loop is used to step up the voltage of power output by the power supply device; the buck loop is used to step down the voltage of power output by the power supply device; and the control unit selects the use of boost loop or buck loop for the voltage conversion of the power supply device.

The boost loop and the buck loop are electrically connected in parallel. The control unit is electrically connected to the boost loop and the buck loop respectively. The control unit monitors the power output of the power supply device and controls the action of the parallel-connected boost loop and buck loop such that the power supply device would output voltage desired by the system via voltage conversion.

The object, features and functions of the invention are described in detail with examples and accompanying drawings below.

### BRIEF DESCRIPTION OF THE DRAWINGS

FIG. 1 is a component diagram of the power supply device with voltage converter circuit according to an embodiment of the invention;

FIG. 2 is a component diagram of the power supply device with voltage converter circuit according to another embodiment of the invention;

FIG. 3 is a component diagram of the power supply device with voltage converter circuit according to yet another embodiment of the invention;

FIG. 4 is a component diagram of the power supply device with voltage converter circuit according to yet another embodiment of the invention;

FIG. 5 is a component diagram of the power supply device with voltage converter circuit according to yet another embodiment of the invention;

FIG. 6 is a component diagram of the power supply device with voltage converter circuit according to yet another embodiment of the invention;

FIG. 7 is a component diagram of the power supply device with voltage converter circuit according to yet another embodiment of the invention; and

FIG. 8 is a component diagram of the power supply device with voltage converter circuit according to yet another embodiment of the invention.

### DETAILED DESCRIPTION OF THE INVENTION

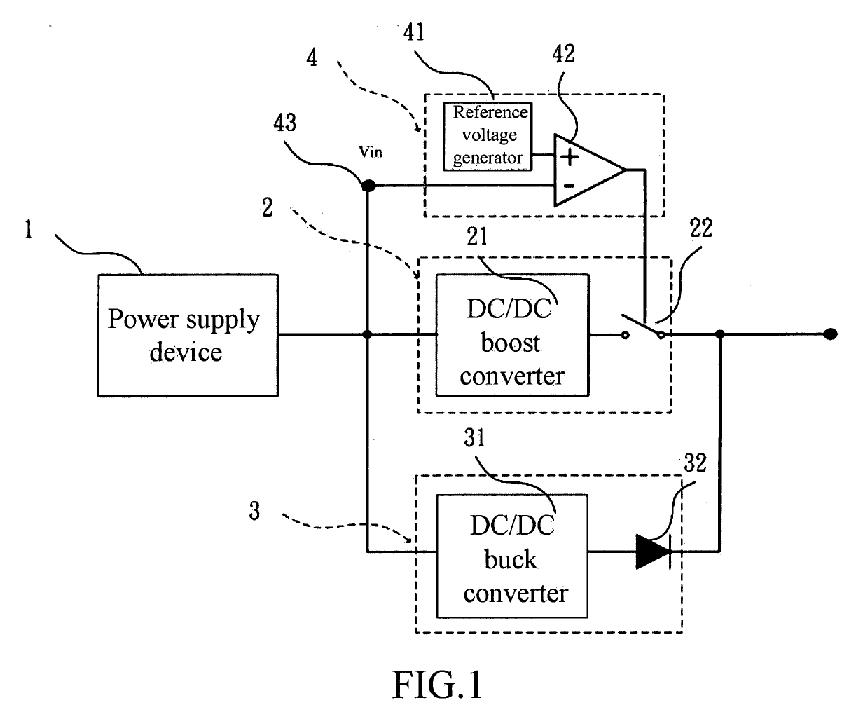

FIG. 1 is a component diagram of the power supply device with voltage converter circuit according to an embodiment of the invention. The power supply device with voltage converter circuit according to the invention comprises a power supply device (1), a boost loop (2), a buck loop (3), and a control unit (4). The power supply device (1) is electrically connected to the boost loop (2). The boost loop (2) and the buck loop (3) are electrically connected in parallel such that power generated by the power supply device (1) can be output at the predetermined voltage level.

In the power supply device with voltage converter circuit of the invention, the power supply device (1) can supply power by any means. In the example of a direct methanol fuel cell, the power supply device uses methanol fuel and oxygen to undergo electrochemical reaction and generate DC power. The boost loop (2) comprises a DC/DC boost converter (21) and a first electric switch (22). The DC/DC boost converter (21) is series-connected to the first electric switch (22) and used to step up the voltage of power output by the power supply device (1) for power output. The first electric switch (22) is used to choose the ON/OFF of the electrical transmission channel of the boost loop (2), and the first electric switch (22) is a diode switch, a metal-oxide semiconductor field-effect transistor (MOSFET) switch, or any other electric-signal controlled switch. The buck loop (3) comprises a DC/DC buck converter (31) and a diode (32). The DC/DC buck converter (31) is electrically connected to the diode (32) in series and used to step down the voltage of power output by the power supply device (1) for power output. The control unit (4) consists of a reference voltage generator (41) and a voltage comparator (42). The control unit (4) is used to select the boost loop (2) or the buck loop (3) for voltage conversion such that the power output by the power supply device (1) is regulated to output power with predetermined voltage level.

The control unit (4) consists of a reference voltage generator (41) and a voltage comparator (42). The voltage comparator (42) compares the output voltage of the power supply device (1) with the reference voltage level provided by the reference voltage generator (41) and outputs a corresponding electric signal to choose the ON/OFF of the first electric switch (22) so that one of the voltage conversion loops—the boost loop (2) and the buck loop (3) is chosen to convert the voltage of power output by the power supply device (1).

The power supply device (1) is series-connected to the electric loop formed by the DC/DC boost converter (21) and the first electric switch (22). The electrical arrangement of the DC/DC boost converter (21) and the first electric switch (22) is switchable whereas the boost loop (2) retains equivalent functions. The DC/DC buck converter (31) in the buck loop (3) is electrically connected to the power output terminal of the power supply device (1) at one end, while electrically connected to the diode (32) at the other end. The diode (32) is electrically connected to the power output terminal of the boost loop (2) such that power with higher voltage level output by the boost loop (2) will not enter the buck loop (3). The voltage comparator (42) in the control unit (4) is electrically connected to the first electric switch (22); the positive end of the voltage comparator (42) is connected to the reference voltage generator (41) and its negative end is connected to a Vin terminal (43). The voltage level at the Vin terminal (43) is equivalent to the output voltage level of the power supply device (1). By comparing the reference voltage generator (41) with the Vin terminal (43), the voltage comparator (42) controls the ON/OFF of the first electric switch (22).

The output voltage of the reference voltage generator (41) is compared with the output voltage of the power supply device (1), and the voltage comparator (42) is used to control the first electric switch (22). When the output voltage of the power supply device (1) is smaller than the output voltage of the reference voltage generator (41), the first electric switch (22) is turned ON, and the boost loop (2) is used to step up the voltage. Conversely the first electric switch (22) is turned OFF, upon which, the buck loop (3) is used to step down the voltage of the power supply device (1) to the desired level.

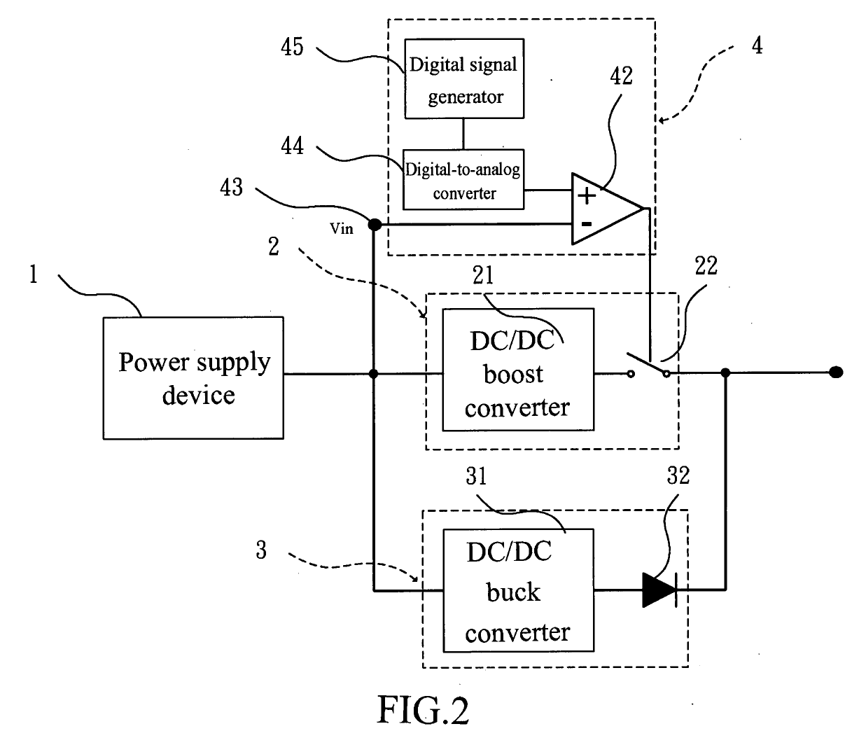

FIG. 2 is a component diagram of the power supply device with voltage converter circuit according to another embodiment of the invention. In this embodiment, the reference voltage generator (41) in the control unit (4) of the power supply device with voltage converter circuit is replaced by a voltage signal supply device comprised of a digital-to-analog converter (44) and a digital signal generator (45).

The electric signal output terminal of the voltage comparator (42) in the control unit (4) is electrically connected to the first electric switch (22). The positive end of the input terminal of the voltage comparator (42) is connected to the digital-to-analog converter (44), while the other end of the digital-to-analog converter (44) is electrically connected to the digital signal generator (45), and the negative end of the input terminal of the voltage comparator (42) is connected to a Vin terminal (43). The voltage level at the Vin terminal (43) is equivalent to the output voltage level of the power supply device (1). By comparing a digital signal generated by the digital signal generator (45) and converted into a voltage value by the digital-to-analog converter (44) with the voltage level at the Vin terminal (43), the difference there between would drive the voltage comparator (42) to control the ON/OFF of the first electric switch (22).

A digital signal generated by the digital signal generator (45) and converted into a voltage value by the digital-to-analog converter (44) is compared with the output voltage of the power supply device (1), and the voltage comparator (42) is used to control the first electric switch (22). When the output voltage of the power supply device (1) is smaller than the output voltage of the reference voltage generator (41), the first electric switch (22) is turned ON, and the boost loop (2) is used to step up the voltage. Conversely the first electric switch (22) is turned OFF, upon which, the buck loop (3) is used to step down the voltage of the power supply device (1) to the desired level.

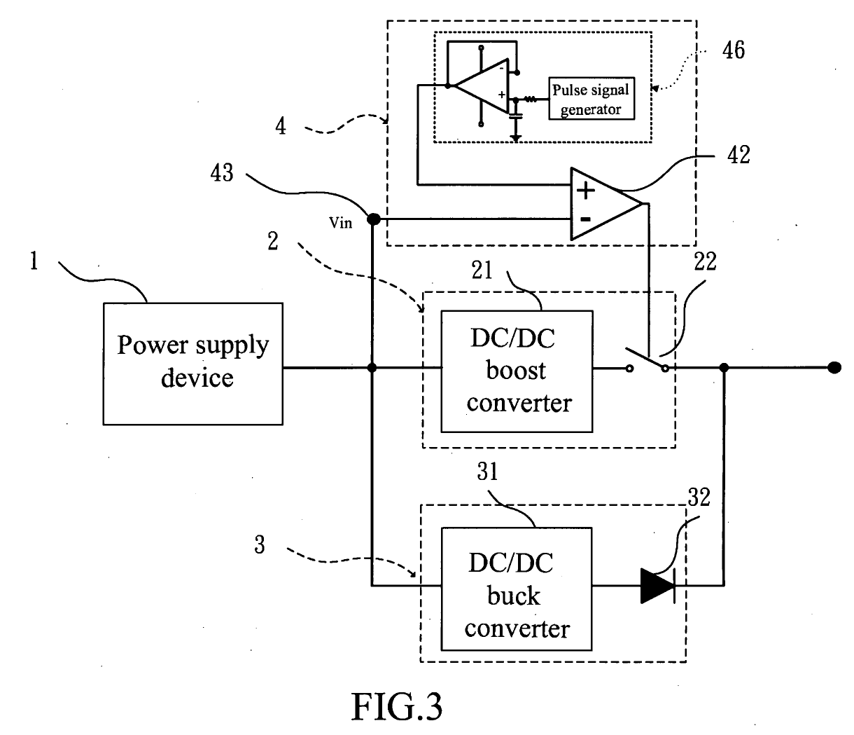

FIG. 3 is a component diagram of the power supply device with voltage converter circuit according to yet another embodiment of the invention. In this embodiment, the power supply device with voltage converter circuit comprises a power supply device (1), a boost loop (2), a buck loop (3) and a control unit (4). The power supply device (1) is electrically connected to the boost loop (2), and the buck loop (3) and the boost loop (2) are parallel-connected. Through such circuit connection, the power generated by the power supply device (1) will have a predetermined voltage.

In the power supply device with voltage converter circuit described above, the control unit (4) consists of a voltage comparator (42) and a voltage output device (46). The control unit (4) selects the use of the boost loop (2) or the buck loop (3) for the voltage conversion of the power supply device (1).

The power supply device (1) is electrically connected to the DC/DC boost converter (21), while the other end of the DC/DC boost converter (21) is electrically connected to the first electric switch (22). The switching between DC/DC boost converter (21) and first electric switch (22) for connection purpose results in the boost loop (2) having the same functions. The DC/DC buck converter (31) in the buck loop (3) is electrically connected to the power supply device (1) at one end, while electrically connected to the diode (32) at the other end. The output terminal of the voltage comparator (42) in the control unit (4) is electrically connected to the first electric switch (22); the positive end of the input terminal of the voltage comparator (42) is connected to the voltage output device (46) and the negative end of the input terminal of the voltage comparator (42) is connected to a Vin terminal (43). The voltage level at the Vin terminal (43) is equivalent to the output voltage level of the power supply device (1). By comparing a voltage value generated by the voltage output device (46) with the voltage level at the Vin terminal (43), the voltage level at the Vin terminal (43) would determine the output voltage of the voltage comparator (42), which controls the ON/OFF of the first electric switch (22).

In the aforesaid embodiment, the voltage output device (46) generates voltage dynamically, which is compared with the output voltage of the power supply device (1), and based on which, the voltage comparator (42) is used to control the first electric switch (22). When the output voltage of the power supply device (1) is smaller than the output voltage of the voltage output device (46), the first electric switch (22) is turned ON, and the boost loop (2) is used to step up the voltage. Conversely the first electric switch (22) is turned OFF, upon which, the buck loop (3) is used to step down the voltage of the power supply device (1) to the desired level.

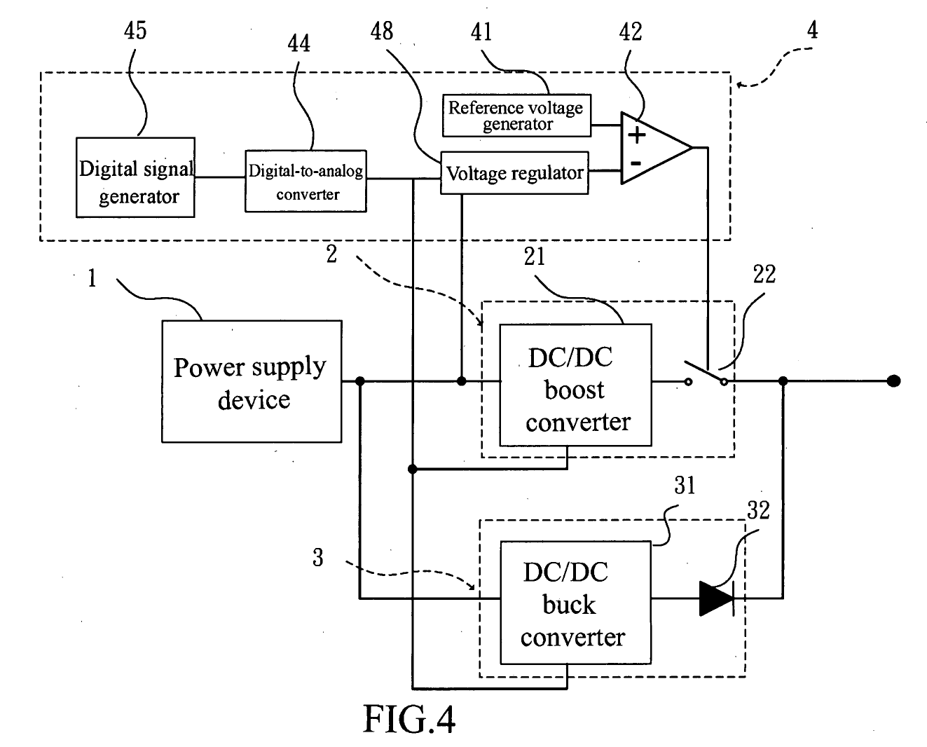

FIG. 4 is a component diagram of the power supply device with voltage converter circuit according to yet another embodiment of the invention. In this embodiment, the power supply device with voltage converter circuit comprises a power supply device (1), a boost loop (2), a buck loop (3) mid a control unit (4). The power supply device (1) is electrically connected to the boost loop (2), and the buck loop (3) and the boost loop (2) are parallel-connected. Through such circuit connection, the power generated by the power supply device (1) will have a predetermined voltage.

In this embodiment, the control unit (4) comprises a reference voltage generator (41), a voltage comparator (42), a digital-to-analog converter (44), a digital signal generator (45), and a voltage regulator (48). The control unit (4) selects the use of the boost loop (2) or the buck loop (3) for the voltage conversion of the power supply device (1).

The power supply device (1) is electrically connected to a DC/DC boost converter (21), while the other end of the DC/DC boost converter (21) is electrically connected to a first electric switch (22). The switching between DC/DC boost converter (21) and first electric switch (22) for connection purpose results in the boost loop (2) having the same functions. The DC/DC buck converter (31) in the buck loop (3) is electrically connected to the power supply device (1) at one end, while electrically connected to a diode (32) at the other end. The output terminal of the voltage comparator (42) in the control unit (4) is electrically connected to the first electric switch (22). The positive end of the voltage comparator (42) is connected to the reference voltage generator (41) and its negative end is connected to the voltage regulator (48). The voltage regulator (48) is electrically connected to the digital-to-analog converter (44) at one end and electrically connected to the output voltage of the power supply device (1) at another end. The other end of the digital-to-analog converter (44) is electrically connected to the digital signal generator (45). A digital signal generated by the digital signal generator (45) and converted into a voltage value by the digital-to-analog converter (44) and the voltage regulator (48) is compared with the output voltage of the reference voltage generator (41), and based on which, the voltage comparator (42) would control the ON/OFF of the first electric switch (22). In addition, the digital signal generator (45), through the voltage signal generated by the digital-to-analog converter (44) could be electrically connected to the DC/DC boost converter (21) and the DC/DC buck converter (31), such that the digital signal generator (45) could control voltage conversion by the DC/DC boost converter (21) and the DC/DC buck converter (31).

In the aforesaid embodiment, a digital signal is generated by the digital signal generator (45) and converted into a voltage value by the digital-to-analog converter (44) and the voltage regulator (48), which is then compared with the output voltage of the reference voltage generator (41), and based on the result of comparison, the voltage comparator (42) is used to control the first electric switch (22). When the signal generated by the digital signal generator (45) and converted into output voltage by the digital-to-analog converter (44) and the voltage regulator (48) is smaller than the output voltage of the reference voltage generator (41), the first electric switch (22) is turned ON, and the voltage of power output by the power supply device (1) will be stepped up via the boost loop (2). Conversely the first electric switch (22) is turned OFF, upon which, the buck loop (3) is used to step down the voltage of the power supply device (1) to the desired level. Because the digital signal generator (45) could generate digital signal dynamically, the conversion of voltage output by the power supply device (1) could also be regulated dynamically.

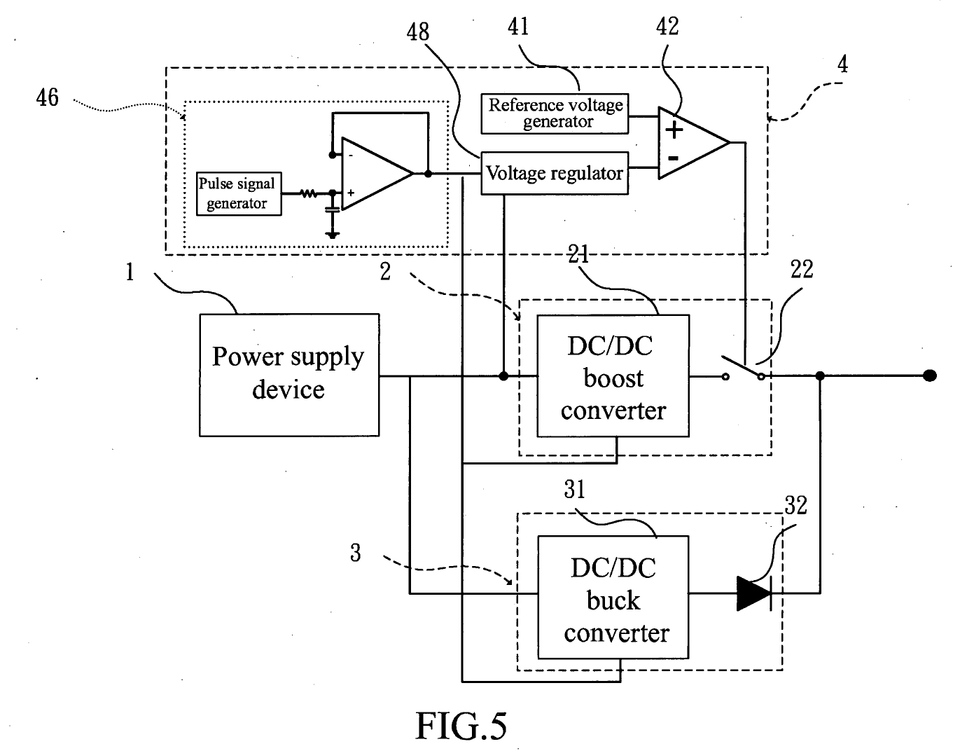

FIG. 5 is a component diagram of the power supply device with voltage converter circuit according to yet another embodiment of the invention. In this embodiment, the power supply device with voltage converter circuit comprises a power supply device (1), a boost loop (2), a buck loop (3) and a control unit (4). The power supply device (1) is electrically connected to the boost loop (2), and the buck loop (3) and the boost loop (2) are parallel-connected. Through such circuit connection, the power generated by the power supply device (1) will have a predetermined voltage.

In this embodiment, the control unit (4) comprises a reference voltage generator (41), a voltage comparator (42), a voltage output device (46), and a voltage regulator (48). The control unit (4) selects the use of the boost loop (2) or the buck loop (3) for the voltage conversion of the power supply device (1).

The power supply device (1) is electrically connected to a DC/DC boost converter (21), while the other end of the DC/DC boost converter (21) is electrically connected to a first electric switch (22). The switching between DC/DC boost converter (21) and first electric switch (22) for connection purpose results in the boost loop (2) having the same functions. The DC/DC buck converter (31) in the buck loop (3) is electrically connected to the power supply device (1) at one end, while electrically connected to a diode (32) at the other end. The output terminal of the voltage comparator (42) in the control unit (4) is electrically connected to the first electric switch (22). The positive end of the input terminal of the voltage comparator (42) is electrically connected to the reference voltage generator (41) and the negative end of its input terminal is electrically connected to the voltage regulator (48) at one end. The voltage regulator (48) is electrically connected to the voltage output device (46) at another end and electrically connected to the output voltage of the power supply device (1) at the other end. The voltage generated by the voltage output device (46) and converted by the voltage regulator (48) is compared with the output voltage of the reference voltage generator (41). The voltage comparator (42) would then choose the ON/OFF of the first electric switch (22) based on the result of comparison, which means choosing either the DC/DC boost converter (21) or the DC/DC buck converter (31) for voltage conversion and thereby controlling the voltage conversion of power output by the power supply device (1).

In the aforesaid embodiment, the voltage generated by the voltage output device (46) and converted by the voltage regulator (48) is compared with the output voltage of the reference voltage generator (41). Based on the result of comparison, the voltage comparator (42) would then control the ON/OFF of the first electric switch (22). Thus when the voltage output by the voltage output device (46) and converted by the voltage regulator (48) is smaller than the output voltage of the reference voltage generator (41), the first electric switch (22) is turned ON, and the voltage of power output by the power supply device (1) will be stepped up via the boost loop (2). Conversely the first electric switch (22) is turned OFF, upon which, the buck loop (3) is used to step down the voltage of the power supply device (1) to the desired level. Because the voltage output device (46) could adjust its voltage value dynamically, the conversion of the voltage output by the power supply device (1) could also be regulated dynamically.

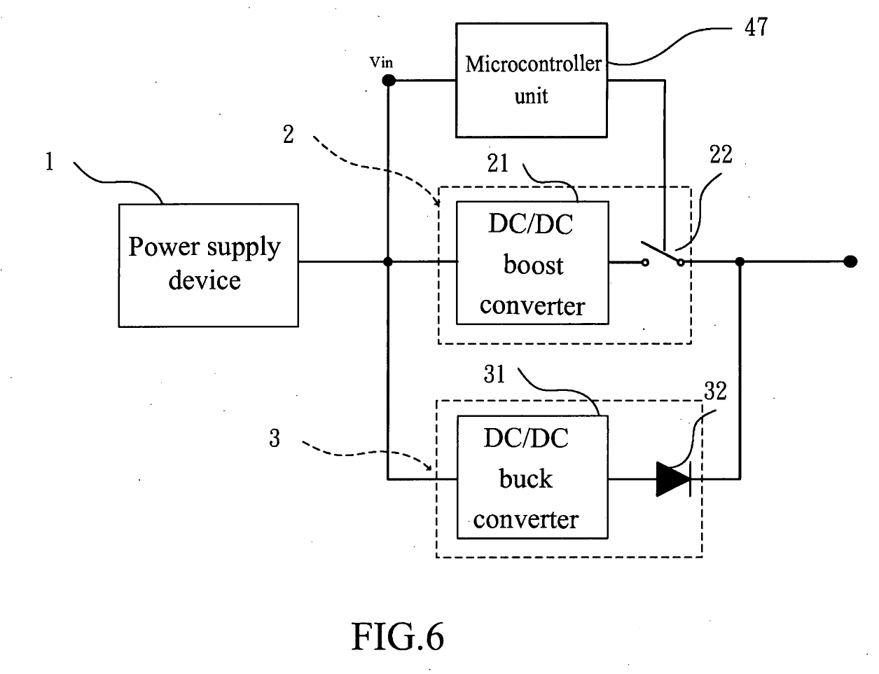

FIG. 6 is a component diagram of the power supply device with voltage converter circuit according to yet another embodiment of the invention. In this embodiment, the power supply device with voltage converter circuit comprises a power supply device (1), a boost loop (2), a buck loop (3) and a microcontroller unit (47). The power supply device (1) is electrically connected to the boost loop (2), and the buck loop (3) and the boost loop (2) are parallel-connected. Through such circuit connection, the power generated by the power supply device (1) will have a predetermined voltage.

The power supply device (1) is electrically connected to a DC/DC boost converter (21), while the other end of the DC/DC boost converter (21) is electrically connected to a first electric switch (22). The switching between DC/DC boost converter (21) and first electric switch (22) for connection purpose results in the boost loop (2) having the same functions. The DC/DC buck converter (31) in the buck loop (3) is electrically connected to the power supply device (1) at one end, while electrically connected to a diode (32) at the other end. The microcontroller unit (47) is electrically connected to the first electric switch (22) of the boost loop (2) and controls the action of the first electric switch (22) through all electric signal.

When the desired voltage set by the system is higher than the output voltage of the power supply device (1), the microcontroller unit (47) controls the first electric switch (22) of boost loop (2) to choose the ON state of the boost loop (2), and the output power of the power supply device (1) would undergo voltage conversion through the boost loop (2) to output power with voltage desired by the system. When the desired voltage set by the system is smaller than the output voltage of the power supply device (1), the microcontroller unit (47) controls the first electric switch (22) of boost loop (2) to choose the OFF state of the boost loop (2), and the output power of the power supply device (1) would undergo voltage conversion through the buck loop (3) to output power with voltage desired by the system.

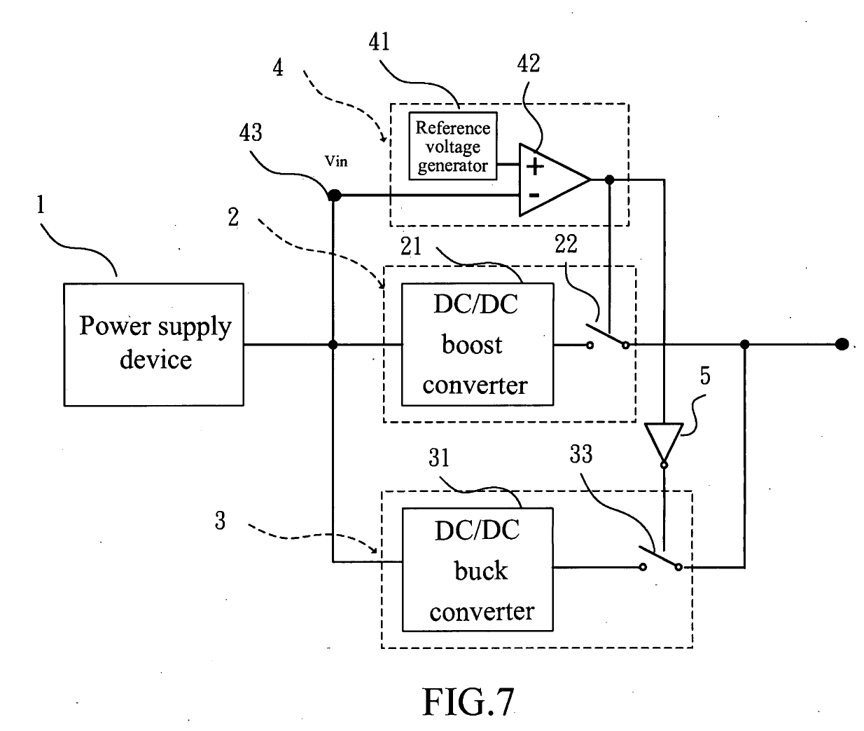

FIG. 7 is a component diagram of the power supply device with voltage converter circuit according to yet another embodiment of the invention. In this embodiment, the power supply device with voltage converter circuit comprises a power supply device (1), a boost loop (2), a buck loop (3), a control unit (4), and an inverter (5). The power supply device (1) is electrically connected to the boost loop (2), and the buck loop (3) and the boost loop (2) are parallel-connected. Through such circuit connection, the power generated by the power supply device (1) will have a predetermined voltage.

The power supply device (1) is electrically connected to a DC/DC boost converter (21), while the other end of the DC/DC boost converter (21) is electrically connected to a first electric switch (22). The switching between DC/DC boost converter (21) and first electric switch (22) for connection purpose results in the boost loop (2) having the same functions. The DC/DC buck converter (31) in the buck loop (3) is electrically connected to the power supply device (1) at one end, while electrically connected to a second electric switch (33) at the other end. The output terminal of the voltage comparator (42) in the control unit (4) is respectively electrically connected to the first electric switch (22) and the inverter (5), and through the inverter (5) electrically connected to the control terminal of the second electric switch (33). The positive end of the input terminal of the voltage comparator (42) is electrically connected to a reference voltage generator (41), while the negative end of the input terminal of the voltage comparator (42) is connected to a Vin terminal (43). The voltage level at the Vin terminal (43) is equivalent to the output voltage level of the power supply device (1). By comparing the output voltage of the reference voltage generator (41) with the voltage level at the Vin terminal (43), the voltage comparator (42) would output a forward-direction signal and a reverse-direction signal to choose the ON or OFF state of the first electric switch (22) and a reverse state for the second electric switch (33).

In the aforesaid embodiment, the output voltage of the reference voltage generator (41) is compared with the output voltage of the power supply device (1), and based on the result of comparison, the voltage comparator (42) controls the actions of the first electric switch (22) and the second electric switch (33). Thus when the output voltage of the power supply device (1) is smaller than the output voltage of the reference voltage generator (41), the electric signal output by the voltage comparator (42) would select the ON state of the first electric switch (22), and the same signal would become an inverted signal through the inverter (5) to select the OFF state of the second electric switch (33). Through the action of the boost loop (2), the voltage of power output by the power supply device (1) is stepped up to the rated voltage level. On the other hand, when the output voltage of the power supply device (1) is higher than the output voltage of the reference voltage generator (41), the electric signal output by the voltage comparator (42) would select the OFF state of the first electric switch (22), and the same signal would become an inverted signal through the inverter (5) to select the ON state of the second electric switch (33). Through the action of the buck loop (3), the voltage of power output by the power supply device (1) is stepped down to the rated voltage level.

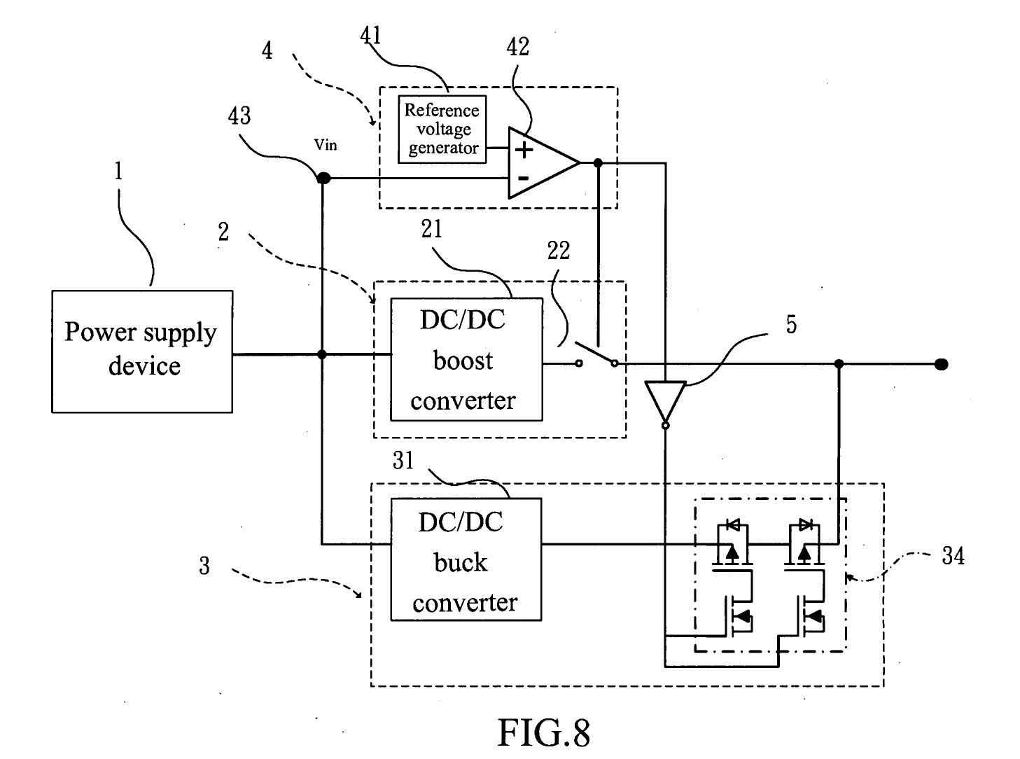

FIG. 8 is a component diagram of the power supply device with voltage converter circuit according to yet another embodiment of the invention. In this embodiment, the power supply device with voltage converter circuit comprises a power supply device (1), a boost loop (2), a buck loop (3), a control unit (4), and an inverter (5). The power supply device (1) is electrically connected to the boost loop (2), and the buck loop (3) and the boost loop (2) are parallel-connected. Through such circuit connection, the power generated by the power supply device (1) will have a predetermined voltage.

The boost loop (2) consists of a DC/DC boost converter (21) and an electric switch (22). The buck loop (3) consists of a DC/DC buck converter (31) and a hack-to-back MOSFET switch set (34). The back-to-back MOSFET switch set (34) comprises two series-connected MOSFET switches where the parasitic diodes within the two MOSFET switches are in opposite direction such that the back-to-back MOSFET switch set (34) could turn off the action of the buck loop (3) and effectively prevent the occurrence of counter current.

In the aforesaid embodiment, the power supply device (1) is electrically connected to a DC/DC boost converter (21), while the other end of the DC/DC boost converter (21) is electrically connected to a first electric switch (22). The switching between DC/DC boost converter (21) and first electric switch (22) for connection purpose results in the boost loop (2) having the same functions. The DC/DC buck converter (31) in the buck loop (3) is electrically connected to the power supply device (1) at one end, while electrically connected to the back-to-back MOSFET switch set (34) at the other end. The output terminal of the voltage comparator (42) in the control unit (4) is respectively electrically connected to the first electric switch (22) and the inverter (5), and through the inverter (5) electrically connected to the back-to-back MOSFET switch set (34). The positive end of the voltage comparator (42) is electrically connected to a reference voltage generator (41), while the negative end of the voltage comparator (42) is connected to a Vin terminal (43). The voltage level at the Vin terminal (43) is equivalent to the output voltage level of the power supply device (1). By comparing the output voltage of the reference voltage generator (41) with the voltage level at the Vin terminal (43), the voltage comparator (42) would control the ON and OFF of the first electric switch (22) and the back-to-back MOSFET switch set (34).

In the aforesaid embodiment, the voltage comparator (42) compares the output voltage of the reference voltage generator (41) with the output voltage of the power supply device (1), and based on the result of comparison, controls the actions of the first electric switch (22) and the back-to-back MOSFET switch set (34). Thus when the output voltage of the power supply device (1) is smaller than the output voltage of the reference voltage generator (41), the electric signal output by the voltage comparator (42) would select the ON state of the first electric switch (22), and the same signal would become an inverted signal through the inverter (5) to select the OFF state of the back-to-back MOSFET switch set (34). Through the action of the boost loop (2), the voltage of power output by the power supply device (1) is stepped up to the rated voltage level. On the other hand, when the output voltage of the power supply device (1) is higher than the output voltage of the reference voltage generator (41), the electric signal output by the voltage comparator (42) would select the OFF state of the first electric switch (22), and the same signal would become an inverted signal through the inverter (5) to select the ON state of the back-to-back MOSFET switch set (34). Through the action of the buck loop (3), the voltage of power output by the power supply device (1) is stepped down to the rated voltage level.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A power supply device with voltage converter circuit, comprising:
a power supply device able to supply power by any means;
a boost loop consisting of a DC/DC boost converter and an electric switch, the DC/DC boost converter being series-connected to the electric switch and for stepping up the voltage of input power;
a buck loop consisting of a DC/DC buck converter and a diode, the DC/DC buck converter being series-connected to the diode and for stepping down the voltage of input power; and
a control unit for selecting the use of the boost loop or the buck loop to convert the voltage of power supply device;
wherein the boost loop and the buck loop are parallel-connected, the control unit being electrically connected to the electric switch of the boost loop, and the control unit selecting the ON or OFF state of the boost loop.

2. The power supply device with voltage converter circuit as claimed in claim 1, wherein the control unit further consists of a voltage comparator and a reference voltage generator, an input terminal of the voltage comparator being electrically connected to the reference voltage generator, another input terminal of the voltage comparator being electrically connected to the output terminal of the power supply device, an electric signal output terminal of the voltage comparator in the control unit being electrically connected to a control terminal of the electric switch and selecting the ON or OFF state of the electric switch, and the boost loop being in a corresponding ON or OFF state.

3. The power supply device with voltage converter circuit as claimed in claim 2, wherein the electric switch is a metal-oxide semiconductor field-effect transistor (MOSFET) switch element, and the control unit is electrically connected to the gate of the electric switch.

4. The power supply device with voltage converter circuit as claimed in claim 2, wherein the control unit further consists of a digital signal generator and a digital-to-analog converter; the digital signal generator being a digital signal generating device and electrically connected to the input terminal of the digital-to-analog converter; and the digital-to-analog converter being a device converting digital signals to analog signals, and its output terminal being electrically connected to the voltage comparator to provide a reference voltage for comparison with the output voltage of the power supply device.

5. The power supply device with voltage converter circuit as claimed in claim 2, wherein the control unit further comprises a voltage output device, the voltage output device consisting of a pulse signal generating device and a pulse to voltage converter loop; the pulse signal generating device being an electric device generating pulse signal with specific duty cycle; and the pulse to voltage converter loop being a device converting a pulse signal into a voltage signal, and the voltage signal output by said pulse to voltage converter loop corresponding to the pulse signal generated by the pulse signal generating device.

6. The power supply device with voltage converter circuit as claimed in claim 5, wherein the pulse to voltage converter loop in the voltage output device of the control unit includes a voltage follower.

7. The power supply device with voltage converter circuit as claimed in claim 2, wherein the control unit further consists of a digital signal generator, a digital-to-analog converter and a voltage regulator; the digital signal generator generating an electric signal through the digital-to-analog converter to control the voltage regulator, and the voltage output by the power supply device and regulated by the voltage regulator being compared with the output voltage of the reference voltage generator by the voltage comparator.

8. The power supply device with voltage converter circuit as claimed in claim 7, wherein the digital-to-analog converter is electrically connected to the DC/DC boost converter in the boost loop and the DC/DC buck converter in the buck loop, and through the electric signal generated by the digital signal generator and converted by the digital-to-analog converter, controls the actions of the DC/DC boost converter and the DC/DC buck converter.

9. The power supply device with voltage converter circuit as claimed in claim 2, wherein the control unit further consists of a voltage output device and a voltage regulator; the voltage output device generating an electric signal to control the voltage regulator, and the voltage output by the power supply device and regulated by the voltage regulator being compared with the output voltage of the reference voltage generator by the voltage comparator.

10. The power supply device with voltage converter circuit as claimed in claim 9, wherein the voltage output device of the control unit is electrically connected to the DC/DC boost converter in the boost loop and the DC/DC buck converter in the buck loop, and through the electric signal generated by the voltage output device, controls the actions of the DC/DC boost converter and the DC/DC buck converter.

11. The power supply device with voltage converter circuit as claimed in claim 1, wherein the control unit is a microcontroller unit for detecting the voltage of the power supply device, and through logic computation and the means of logic control, controls the actions of the boost loop and the buck loop.

12. A power supply device with voltage converter circuit comprising:
a power supply device able to supply power by any means;
a boost loop consisting of a DC/DC boost converter and a first electric switch, the DC/DC boost converter being series-connected to the first electric switch and for stepping up the voltage of input power;
a buck loop consisting of a DC/DC buck converter and a second electric switch, the DC/DC buck converter being series-connected to the second electric switch and for stepping down the voltage of input power; and
a control unit for selecting the use of the boost loop or the buck loop to convert the voltage of power supply device;
wherein the boost loop and the buck loop are parallel-connected, the control unit being electrically connected to the electric switch of the boost loop, and the control unit selecting the ON or OFF state of the boost loop.

13. The power supply device with voltage converter circuit as claimed in claim 12, wherein the control unit further consists of a voltage comparator and a reference voltage generator, an input terminal of the voltage comparator being electrically connected to the reference voltage generator, another input terminal of the voltage comparator being electrically connected to the output terminal of the power supply device, an electric signal output terminal of the voltage comparator in the control unit being electrically connected to a control terminal of the first electric switch and selecting the ON or OFF state of the first electric switch, and the boost loop being in a corresponding ON or OFF state.

14. The power supply device with voltage converter circuit as claimed in claim 13, wherein the electric signal output terminal of the voltage comparator in the control unit is further electrically connected to the input terminal of an inverter, the output terminal of said inverter being electrically connected to the control terminal of the second electric switch in the buck loop.

15. The power supply device with voltage converter circuit as claimed in claim 14, wherein the second electric switch of the buck loop is a back-to-back MOSFET switch set, the back-to-back MOSFET switch set comprising two series-connected MOSFET switches and the parasitic diodes within the two MOSFET switches being in opposite direction; and the output terminal of the inverter being respectively electrically connected to the two MOSFET switches in the back-to-back MOSFET switch set.
